(19) United States
(12) Patent Application Publication
(10) Pub. No.: US 2022/0359891 A1
(43) Pub. Date: Nov. 10, 2022

(54) DEVICE AND METHOD FOR GUIDING HYDROGEN CHARGING STATION

(71) Applicants: Hyundai Motor Company, Seoul (KR); Kia Corporation, Seoul (KR)

(72) Inventor: Tae Ho LEE, Seoul (KR)

(73) Assignees: Hyundai Motor Company, Seoul (KR); Kia Corporation, Seoul (KR)

(21) Appl. No.: 17/506,424

(22) Filed: Oct. 20, 2021

(30) Foreign Application Priority Data
May 4, 2021 (KR) 10-2021-0057977

(51) Int. Cl. H01M 8/04082; F17C 5/06; B60W 50/14; B60K 15/03

(52) U.S. Cl. CPC H01M 8/04201; F17C 5/06; B60W 50/14; B60K 15/03; F17C 2221/012; H01M 2250/20; B60K 2015/03315; F17C 2250/0421; F17C 2250/0615; B60K 2015/03019; B60K 2015/03203

(57) ABSTRACT

In a device and a method for guiding a hydrogen fueled vehicle based on a hydrogen pressure of a fuel tank of the hydrogen charging station, information on a hydrogen charging station including the hydrogen pressure of the fuel tank of the hydrogen charging station is received from a server, and a charging station determined to be suitable for charging the hydrogen fueled vehicle is selected in consideration of an importance of each item obtained from a user of the hydrogen fueled vehicle based on items including at least one of a price of hydrogen charging, a charging standby time, a charging taking time, whether the hydrogen fueled vehicle is able to be fully charged, and a distance to the hydrogen charging station determined based on the information on the hydrogen charging station.

### CROSS-REFERENCE TO RELATED APPLICATION

The present application claims priority to Korean Patent Application No. 10-2021-0057977, filed on May 4, 2021, the entire contents of which is incorporated herein for all purposes by this reference.

### BACKGROUND OF THE INVENTION

### Field of the Invention

The present invention relates to a device and a method for guiding a hydrogen fueled vehicle, and more particularly, to a device and a method for guiding a hydrogen fueled vehicle based on a hydrogen pressure in a fuel tank of the hydrogen charging station.

### Description of Related art

A hydrogen fueled vehicle using hydrogen as a fuel is an eco-friendly vehicle that does not generate exhaust gas other than water. In a case of the hydrogen fueled vehicle, because a charging station is filled with hydrogen, and then, a fuel tank of the hydrogen fueled vehicle is filled with gas, a hydrogen pressure must be adjusted accordingly. In general, a hydrogen charger at the hydrogen charging station has a poor charging efficiency compared to an internal combustion engine vehicle and an electric vehicle. With current technology, it is possible for one charger to charge about 20 hydrogen fueled vehicles for each day. Furthermore, when a pressure of the hydrogen charger at the hydrogen charging station is lower than a pressure in a hydrogen tank of the vehicle, the charging is not able to be performed.

Accordingly, because a charging time of the hydrogen fueled vehicle at the hydrogen charging station may be significantly longer than that of other fueled vehicles, a user may have a desire to select a charging station suitable for a situation thereof. In other words, a development of a technology of guiding the hydrogen charging station suitable for the situation of the user by reflecting the desire of the user to charge the hydrogen fueled vehicle is emerging.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a device and a method for guiding a hydrogen fueled vehicle based on a hydrogen pressure in a fuel tank of the hydrogen charging station.

Various aspects of the present invention provide a device and a method for guiding a hydrogen fueled vehicle which may save time for a user of a hydrogen fueled vehicle by recommending a charging station suitable for charging the hydrogen fueled vehicle.

Various aspects of the present invention provide a device and a method for guiding a hydrogen fueled vehicle which may provide the highest economic satisfaction to a user by guiding a charging station in consideration of a price, a balance, an economic benefit, and the like.

Various aspects of the present invention provide a device and a method for guiding a hydrogen fueled vehicle which may give a user great satisfaction by guiding a charging station with high satisfaction in consideration of a personal taste of the user by reflecting a preference of the user.

Various aspects of the present invention provide a device and a method for guiding a hydrogen fueled vehicle which may guide a more improved hydrogen charging station in a next round by reflecting a hydrogen charging station selected by a user or feedback of the user.

The technical problems to be solved by the present inventive concept are not limited to the aforementioned problems, and any other technical problems not mentioned herein will be clearly understood from the following description by those skilled in the art to which various exemplary embodiments of the present invention pertains.

According to various aspects of the present invention, a device configured for guiding a hydrogen charging station includes a communication device configured for receiving information on the hydrogen charging station including a hydrogen pressure of a fuel tank of the hydrogen charging station from a server, and a controller that selects a charging station determined to be suitable for charging a hydrogen fueled vehicle in consideration of an importance of each item obtained from a user of the hydrogen fueled vehicle based on items including at least one of a price of hydrogen charging, a charging standby time, a charging taking time, whether the hydrogen fueled vehicle is able to be fully charged, and a distance to the hydrogen charging station determined based on the information on the hydrogen charging station.

In various exemplary embodiments of the present invention, the device may further include an input device configured for receiving a weight based on the importance of each item from the user, and the controller may select the hydrogen charging station determined to be suitable for charging the hydrogen fueled vehicle based on the items determined based on the information on the hydrogen charging station in consideration of the received weight.

In various exemplary embodiments of the present invention, the controller may select the hydrogen charging station determined to be suitable for charging the hydrogen fueled vehicle in consideration of the importance of the items based on the user determined based on information on a hydrogen charging station selected by the user in the past.

In various exemplary embodiments of the present invention, the controller may adjust a weight based on the importance of the items based on an item determined for a hydrogen charging station selected in the past, and select the hydrogen charging station determined to be suitable for charging the hydrogen fueled vehicle in consideration of the adjusted weight.

In various exemplary embodiments of the present invention, the controller may select the hydrogen charging station determined to be suitable for charging the hydrogen fueled vehicle in consideration of feedback of the user on a charging station determined to be suitable for charging the hydrogen fueled vehicle selected in the past.

In various exemplary embodiments of the present invention, the controller may adjust a weight based on the importance of the item using the feedback of the user, and select the hydrogen charging station determined to be suitable for charging the hydrogen fueled vehicle in consideration of the adjusted weight.

In various exemplary embodiments of the present invention, the controller may select the hydrogen charging station determined to be suitable for charging the hydrogen fueled vehicle in consideration of a schedule of the user identified through the hydrogen fueled vehicle.

In various exemplary embodiments of the present invention, the controller may select the hydrogen charging station determined to be suitable for charging the hydrogen fueled vehicle based on whether it is determined through the schedule that the user needs to urgently arrive at a destination.

In various exemplary embodiments of the present invention, the controller may select the hydrogen charging station determined to be suitable for charging the hydrogen fueled vehicle based on whether it is determined through the schedule that the user needs to travel a distance longer than a predetermined distance.

In various exemplary embodiments of the present invention, the controller may select the hydrogen charging station determined to be suitable for charging the hydrogen fueled vehicle in consideration of a financial status of the user identified through the hydrogen fueled vehicle.

In various exemplary embodiments of the present invention, the controller may select the hydrogen charging station determined to be suitable for charging the hydrogen fueled vehicle in consideration of a payment method of the user identified through the hydrogen fueled vehicle and a benefit based on the hydrogen charging station.

According to various aspects of the present invention, a method for guiding a hydrogen fueled vehicle includes receiving, by a communication device, information on the hydrogen charging station including a hydrogen pressure of a fuel tank of the hydrogen charging station from a server, and selecting, by a controller, a charging station determined to be suitable for charging a hydrogen fueled vehicle in consideration of an importance of each item obtained from a user of the hydrogen fueled vehicle based on items including at least one of a price of hydrogen charging, a charging standby time, a charging taking time, whether the hydrogen fueled vehicle is able to be fully charged, and a distance to the hydrogen charging station determined based on the information on the hydrogen charging station.

In various exemplary embodiments of the present invention, the method may further include receiving, by an input device, a weight based on the importance of each item from the user, and the selecting, by the controller, of the hydrogen charging station determined to be suitable for charging the hydrogen fueled vehicle may include selecting, by the controller, the hydrogen charging station determined to be suitable for charging the hydrogen fueled vehicle based on the items determined based on the information on the hydrogen charging station in consideration of the received weight.

In various exemplary embodiments of the present invention, the method may further include adjusting, by the controller, a weight based on the importance of the items based on an item determined for a hydrogen charging station selected in the past, and the selecting, by the controller, of the hydrogen charging station determined to be suitable for charging the hydrogen fueled vehicle may include selecting, by the controller, the hydrogen charging station determined to be suitable for charging the hydrogen fueled vehicle in consideration of the adjusted weight.

In various exemplary embodiments of the present invention, the method may further include adjusting, by the controller, a weight based on the importance of the items based on feedback of the user on a charging station determined to be suitable for charging the hydrogen fueled vehicle selected in the past, and the selecting, by the controller, of the hydrogen charging station determined to be suitable for charging the hydrogen fueled vehicle may include selecting, by the controller, the hydrogen charging station determined to be suitable for charging the hydrogen fueled vehicle in consideration of the adjusted weight.

In various exemplary embodiments of the present invention, the selecting, by the controller, of the hydrogen charging station determined to be suitable for charging the hydrogen fueled vehicle may include selecting, by the controller, the hydrogen charging station determined to be suitable for charging the hydrogen fueled vehicle in consideration of a schedule of the user identified through the hydrogen fueled vehicle.

In various exemplary embodiments of the present invention, the selecting, by the controller, of the hydrogen charging station determined to be suitable for charging the hydrogen fueled vehicle in consideration of the schedule of the user may include selecting, by the controller, the hydrogen charging station determined to be suitable for charging the hydrogen fueled vehicle based on whether it is determined through the schedule that the user needs to urgently arrive at a destination.

In various exemplary embodiments of the present invention, the selecting, by the controller, of the hydrogen charging station determined to be suitable for charging the hydrogen fueled vehicle in consideration of the schedule of the user may include selecting, by the controller, the hydrogen charging station determined to be suitable for charging the hydrogen fueled vehicle based on whether it is determined through the schedule that the user needs to travel a distance longer than a predetermined distance.

In various exemplary embodiments of the present invention, the selecting, by the controller, of the hydrogen charging station determined to be suitable for charging the hydrogen fueled vehicle may include selecting, by the controller, the hydrogen charging station determined to be suitable for charging the hydrogen fueled vehicle in consideration of a financial status of the user identified through the hydrogen fueled vehicle.

In various exemplary embodiments of the present invention, the selecting, by the controller, of the hydrogen charging station determined to be suitable for charging the hydrogen fueled vehicle may include selecting, by the controller, the hydrogen charging station determined to be suitable for charging the hydrogen fueled vehicle in consideration of a payment method of the user identified through the hydrogen fueled vehicle and a benefit based on the hydrogen charging station.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram showing a hydrogen charging station guiding device according to various exemplary embodiments of the present invention;

FIG. 2 is a block diagram showing a hydrogen charging station guiding device according to various exemplary embodiments of the present invention;

FIG. 3 is a diagram showing that a hydrogen charging station guiding device according to various exemplary embodiments of the present invention collects information;

FIG. 4 is a diagram showing information used for hydrogen charging station selection by a hydrogen charging station guiding device according to various exemplary embodiments of the present invention;

FIG. 5 is a diagram showing that a hydrogen charging station guiding device according to various exemplary embodiments of the present invention adjusts a weight based on a charging station selected by a user in the past;

FIG. 6 is a view showing that a hydrogen charging station guiding device according to various exemplary embodiments of the present invention adjusts a weight based on feedback of a user; and

FIG. 7 is a flowchart showing a hydrogen charging station guiding method according to various exemplary embodiments of the present invention.

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments of the present invention will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present invention, a detailed description of the related known configuration or function will be omitted when it is determined that it interferes with the understanding of the exemplary embodiment of the present invention.

In describing the components of the exemplary embodiment according to various exemplary embodiments of the present invention, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

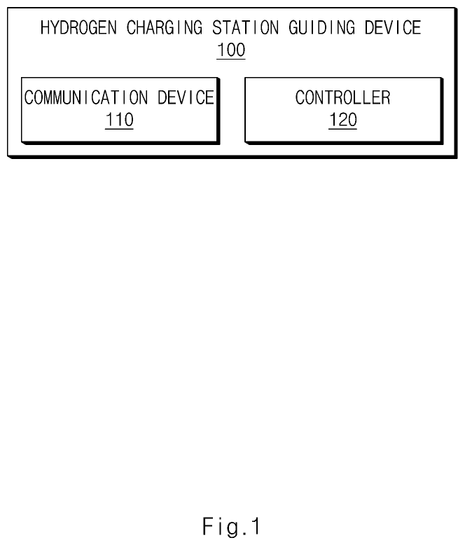

Hereinafter, embodiments of the present invention will be described in detail with reference to FIGS. 1 to 7.

FIG. 1 is a block diagram showing a hydrogen charging station guiding device according to various exemplary embodiments of the present invention.

Referring to FIG. 1, a hydrogen charging station guiding device 100 may include a communication device 110 and a controller 120.

As an example, the hydrogen charging station guiding device 100 may be implemented integrally with a hydrogen fueled vehicle, implemented in a form of being installed in/attached to the vehicle as a component separate from the hydrogen fueled vehicle, or implemented in a form in which a portion thereof is implemented integrally with the hydrogen fueled vehicle, and the remaining portion thereof is installed in/attached to the hydrogen fueled vehicle as a component separate from the hydrogen fueled vehicle.

The communication device 110 may communicate with an external server to receive external situation information and the like. The communication device 110 may transmit/receive data using various communication schemes. For example, the communication device 110 may use a Wi-Fi, a Bluetooth, a Zigbee, an ultra-wide band (UWB) communication, and a near field communication (NFC).

The communication device 110 may receive information on a hydrogen charging station including a hydrogen pressure of a fuel tank of the hydrogen charging station from the server.

As an example, the communication device 110 may receive information on a location of the hydrogen charging station, a charging time, a charging station brand (company), a payment benefit provided from the charging station, and the like from the server.

As an example, the communication device 110 may transmit the information on the hydrogen charging station by being directly or indirectly connected to the controller 120 in a wireless or wired manner.

As an example, the communication device 110 may be connected to the controller 120 through an in-vehicle communication, such as a controller area network (CAN) communication, a Local Interconnect Network (LIN) communication, and the like.

The controller 120 may perform overall control such that each component may perform a function thereof normally. The controller 120 may be implemented in a form of hardware, software, or a combination of the hardware and the software. The controller 120 may be implemented as a microprocessor, but may not be limited thereto. Furthermore, the controller 120 may perform various data processing and determinations, which will be described later.

The controller 120 may select a charging station which is determined to be suitable for charging the hydrogen fueled vehicle in consideration of an importance of each item obtained from a user of the hydrogen fueled vehicle based on items including at least one of a price of hydrogen charging, a charging standby time, a charging taking time, whether the vehicle is able to be fully charged, and/or a distance to the charging station, which are determined based on the information on the hydrogen charging station.

The controller 120 may obtain information on the vehicle itself, information on a preference of the vehicle user, and information on a schedule and a situation of the user.

As an example, the controller 120 may obtain information on a maximum pressure of the fuel tank of the hydrogen fueled vehicle, a current pressure of the fuel tank, and a location of the hydrogen fueled vehicle.

As an example, the controller 120 may obtain the information on the maximum pressure of the fuel tank through vehicle design information, obtain the information on the current pressure of the fuel tank through a pressure sensor disposed in the fuel tank, and obtain the information on the location of the hydrogen fueled vehicle through a global positioning system (GPS).

As an example, the controller 120 may obtain the information on the preference of the vehicle user by receiving the same directly from the user or by learning the same by itself through various information.

As an example, the controller 120 may obtain the information on the schedule and the situation of the user through a connected car system of the vehicle or a vehicle payment system.

As an example, the controller 120 may obtain information on a destination based on an event and a travel schedule stored in a calendar of the user, or the like through the connected car system of the vehicle.

As an example, the controller 120 may obtain information on an account balance of the user, a monthly charged amount of money, a payment scheme based on a payment account, a type and a brand of a registered card, and the like through the vehicle payment system.

As an example, the controller 120 may select the charging station suitable for charging the hydrogen fueled vehicle in consideration of the importance of the item based on the user, which is determined based on information on a hydrogen charging station selected by the user in the past.

As an example, the hydrogen charging station guiding device 100 may select one or more hydrogen charging stations determined to be suitable, and may provide the user with information on the selected hydrogen charging station.

Accordingly, the hydrogen charging station guiding device 100 may receive the information on the hydrogen charging station selected by the user from the user.

As an example, the controller 120 may adjust a weight based on the importance of the items based on an item determined for the hydrogen charging station selected in the past, and select the charging station which is determined to be suitable for charging the hydrogen fueled vehicle in consideration of the adjusted weight.

As an example, the controller 120 may adjust a weight which is previously set as a default value or determined through an input of the user or learning based on the information on the hydrogen charging station selected by the user.

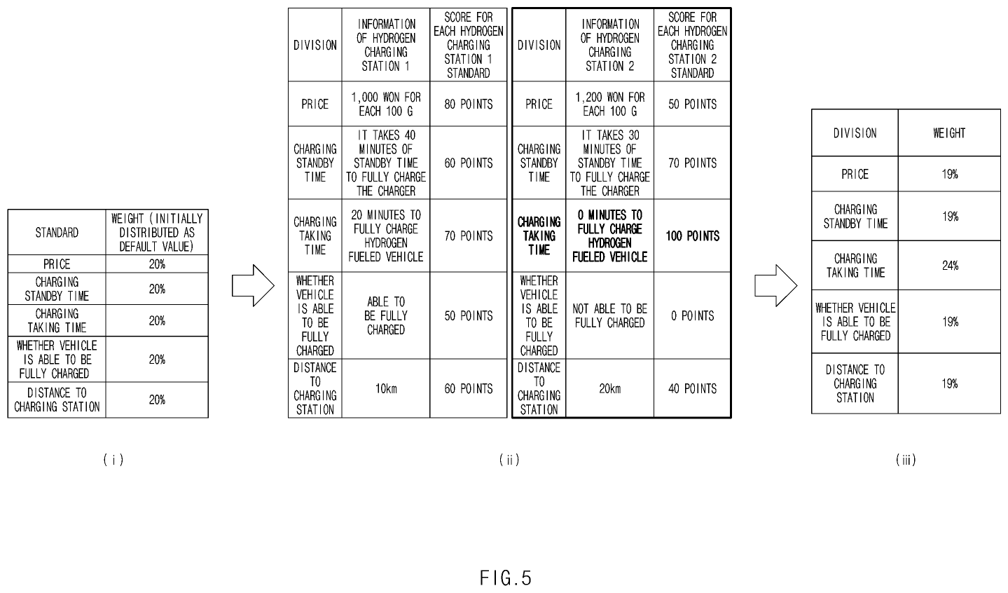

FIG. 5 illustrates an example in which the controller 120 adjusts the weight based on the information on the hydrogen charging station selected by the user.

As an example, the controller 120 may select the charging station which is determined to be suitable for charging the hydrogen fueled vehicle in consideration of feedback of the user on a charging station, which is determined to be suitable for charging the hydrogen fueled vehicle, selected in the past.

As an example, the hydrogen charging station guiding device 100 may receive the feedback of the user on the hydrogen charging station which is determined to be suitable, and thus, selected.

As an example, the feedback of the user may include information on satisfaction or dissatisfaction with the selected hydrogen charging station.

As an example, the controller 120 may adjust the weight based on the importance of the item using the feedback of the user, and select the charging station which is determined to be suitable for charging the hydrogen fueled vehicle in consideration of the adjusted weight.

As an example, the controller 120 may adjust the weight which is previously set as the default value or determined through the input of the user or the learning based on the information on the feedback of the user.

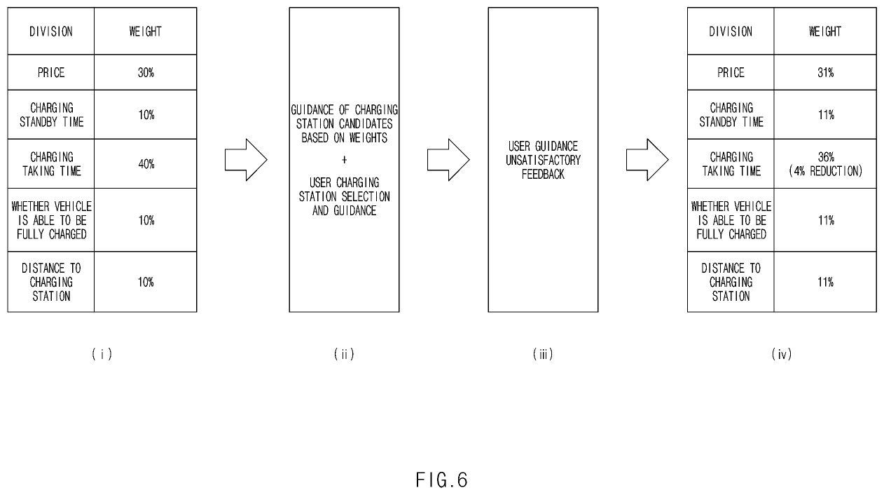

An example in which the controller 120 adjusts the weight based on the feedback of the user will be illustrated in FIG. 6.

As an example, the controller 120 may select the charging station determined to be suitable for charging the hydrogen fueled vehicle in consideration of the schedule of the user identified through the hydrogen fueled vehicle.

As an example, the controller 120 may determine, based on the schedule of the user identified through the connected car system of the hydrogen fueled vehicle, whether the user is in a situation in which the user needs to urgently arrive at a destination or in a situation in which the user needs to travel a long distance.

As an example, the controller 120 may compare a current estimated time of arrival at the destination with a time of the event stored in the calendar, and when it is determined that there is a difference therebetween less than a preset threshold time, determine that the user is when the user needs to urgently arrive at the destination.

As an example, when a distance to the destination exceeds a preset threshold distance, the controller 120 may determine that the user is when the user needs to travel the long distance.

As an example, the controller 120 may select the charging station determined to be suitable for charging the hydrogen fueled vehicle based on whether it is determined that the user is when the user needs to urgently arrive at the destination.

As an example, when it is determined that the user is when the user needs to urgently arrive at the destination, the controller 120 may select the charging station determined to be suitable for charging the hydrogen fueled vehicle to minimize a time required by partial charging, even though it is not full charging.

When it is determined that the user is when the user needs to urgently arrive at the destination, the controller 120 may lower a weight for whether the vehicle is able to be fully charged and select the charging station which is determined to be suitable for charging the hydrogen fueled vehicle.

As an example, the controller 120 may select the charging station determined to be suitable for charging the hydrogen fueled vehicle based on whether it is determined through the schedule that the user is when the user needs to travel the long distance.

As an example, when it is determined that the user is when the user needs to travel the long distance, the controller 120 may select a charging station at which fuel for traveling along a route may be charged as the charging station which is determined to be suitable for charging the hydrogen fueled vehicle, or select a charging station at which the full charging is possible as the charging station which is determined to be suitable for charging the hydrogen fueled vehicle.

As an example, the controller 120 may select a hydrogen charging station having a maximum pressure to allow the hydrogen fueled vehicle to travel to the destination with one time charging as the charging station determined to be suitable for charging the hydrogen fueled vehicle.

In the instant case, when it is not possible to reach the destination at once only with the partial charging, the controller 120 may select a hydrogen charging station that allows the hydrogen fueled vehicle to reach the destination with one time full charging as the charging station determined to be suitable for charging the vehicle even when it takes a little longer.

As an example, the controller 120 may select the charging station determined to be suitable for the hydrogen charging in consideration of a financial status of the user identified through the hydrogen fueled vehicle.

As an example, when it is determined that a budget of the user is insufficient or limited by comparing the account balance of the user and the monthly charged amount of money through a user profile, the vehicle payment system, or the like, the controller 120 may select a low-cost charging station as the charging station determined to be suitable for charging the hydrogen fueled vehicle.

When it is determined that the budget of the user is insufficient or limited, the controller 120 may increase a weight provided to the item of the price of the hydrogen charging and select the charging station determined to be suitable for charging the hydrogen fueled vehicle.

As an example, the controller 120 may select the charging station determined to be suitable for the hydrogen charging in consideration of a payment method of the user identified through the hydrogen fueled vehicle and the benefit based on the hydrogen charging station.

As an example, the controller 120 may select the charging station determined to be suitable for the hydrogen charging based on the hydrogen charging price taking into account the benefit that the brand (company) of the charging station provides for a card or the payment scheme based on the payment account of the user.

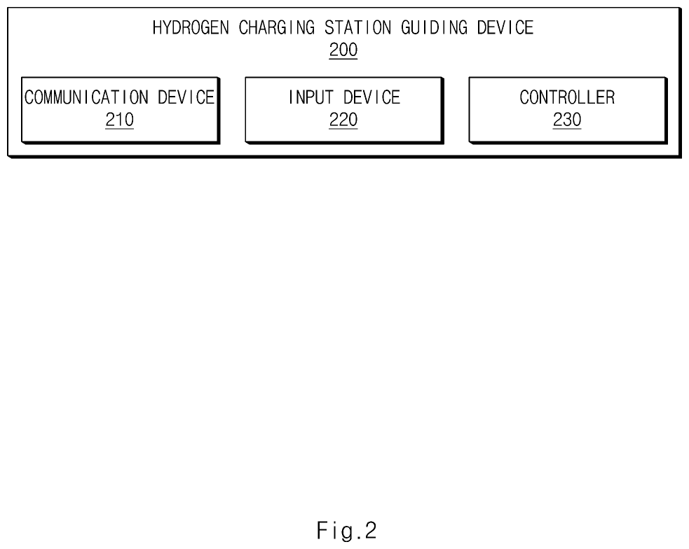

FIG. 2 is a block diagram showing a hydrogen charging station guiding device according to various exemplary embodiments of the present invention.

Referring to FIG. 2, a hydrogen charging station guiding device 200 may include a communication device 210, an input device 220, and a controller 230.

The communication device 210 is the same as the communication device 110 in FIG. 1, so that a description thereof will be omitted.

The input device 220 may receive the weight based on the importance of the item from the user.

As an example, the input device 220 may include an input module that receives the information from the user.

The input module may generate a control signal in a response to an input from the outside. To the present end, the input module may be formed as an input device such as a keypad, a touch pad, a touch screen, and the like. When the input module is formed as the touch screen, the input module may also perform a function of an output module.

As an example, the input module may be implemented in an Audio, Video, Navigation (AVN) of the hydrogen fueled vehicle.

The user may input the weight based on the importance considered in a process of evaluating the hydrogen charging station that the user thinks through the input device 220.

The controller 230 may select the charging station determined to be suitable for charging the hydrogen fueled vehicle based on the item determined based on the information on the hydrogen charging station in consideration of the received weight.

As an example, the controller 230 may determine scores for the items including the price, the charging standby time, the charging taking time, whether the vehicle is able to be fully charged, and the distance to the charging station, and multiplies weight ratios to the determined scores to determine final scores for the items, respectively.

As an example, the controller 230 may determine a score for each hydrogen charging station by summing the determined final scores, and compare the scores of the hydrogen charging stations with each other to select the hydrogen charging station which is determined to be suitable for the hydrogen charging to be guided to the user.

Although not redundantly described, the controller 230 may perform the functions described in the controller 120 in FIG. 1.

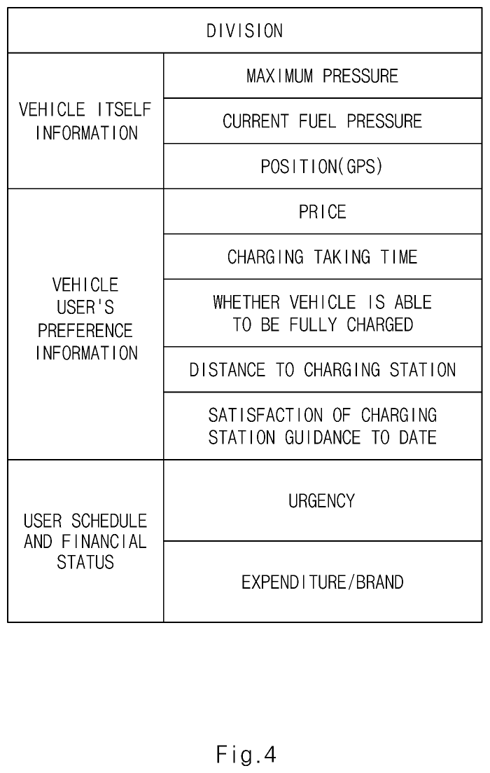

For each item that the controller 230 determines for the hydrogen charging station will be described in detail in FIG. 4.

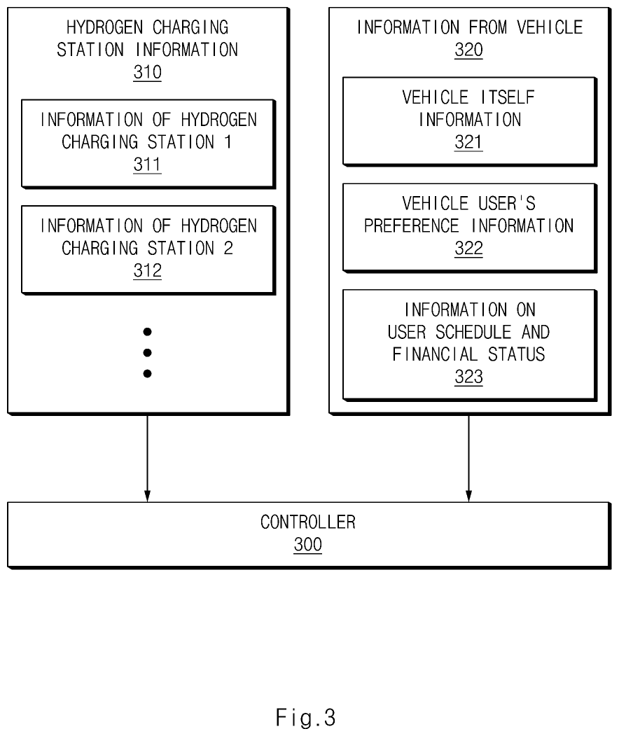

FIG. 3 is a diagram showing that a hydrogen charging station guiding device according to various exemplary embodiments of the present invention collects information.

Referring to FIG. 3, a controller 300 of the hydrogen charging station guiding device may obtain hydrogen charging station information 310 and information 320 from the vehicle.

As an example, the controller 300 may obtain the hydrogen charging station information 310 from the server through the communication device 110.

As an example, the hydrogen charging station information 310 may include information 311 of a hydrogen charging station 1 and information 312 of a hydrogen charging station 2.

As an example, the hydrogen charging station information 310 may receive information on hydrogen charging stations obtainable by the server.

As an example, the hydrogen charging station information 310 may include information on a pressure of a fuel tank of each hydrogen charging station, information on the location of the hydrogen charging station, information on the payment benefit based on the brand of the hydrogen charging station, and the like.

As an example, the hydrogen charging station information 310 may include information on a pressure, a charging time, and the like of each charger of the hydrogen charging station.

The information on the pressure measured by a pressure sensor in the fuel tank of each hydrogen charging station may be transmitted to the server and collected, and may be transmitted from the server to the hydrogen charging station guiding device.

As an example, the controller 300 may obtain the information 320 from the vehicle through the information input from the user through the in-vehicle communication (the CAN communication, the LIN communication, and the like) or the input module, the connected car system of the vehicle, the vehicle payment system, and the like.

The information 320 from the vehicle may include at least one of vehicle itself information 321, vehicle user's preference information 322, and/or information 323 on the user schedule and the financial status.

As an example, the controller 300 may obtain the vehicle itself information 321 through vehicle design information.

As an example, the controller 300 may obtain the vehicle design information stored in a memory through the in-vehicle communication.

As an example, the controller 300 may obtain the vehicle user's preference information 322 by receiving the same directly from the user or by learning the same through the various information.

As an example, the controller 300 may obtain the information 323 on the user schedule and the financial status through the connected car system of the vehicle or the vehicle payment system.

FIG. 4 is a diagram showing information used for hydrogen charging station selection by a hydrogen charging station guiding device according to various exemplary embodiments of the present invention.

Referring to FIG. 4, the hydrogen charging station guiding device 100 may select the hydrogen charging station which is determined to be suitable for the hydrogen charging may using at least one of the vehicle itself information, the vehicle user's preference information, and/or the information on the user schedule and the financial status.

The vehicle itself information may include the maximum pressure of the fuel tank of the vehicle, the current pressure of the fuel tank of the vehicle, and the location of the vehicle.

As an example, the maximum pressure of the fuel tank of the vehicle may be identified through the vehicle design information, the current pressure of the fuel tank of the vehicle may be identified through the pressure sensor disposed in the fuel tank of the vehicle, and the location of the vehicle may be identified through the Global Positioning System (GPS) provided in the vehicle.

The vehicle user's preference information may include the importance obtained from the user of the items including at least one of the price of hydrogen charging, the charging standby time, the charging taking time, whether the vehicle is able to be fully charged, the distance to the charging station, and/or satisfaction of the charging station guidance to date.

As an example, the vehicle user's preference information may include information on a weight percent provided to each of the items including at least one of the price of hydrogen charging, the charging standby time, the charging taking time, whether the vehicle is able to be fully charged, the distance to the charging station, and/or the satisfaction of the charging station guidance to date.

As an example, the information on the weight percent provided to each item may be directly input from the user, or may be learned and identified through various information.

The price item may refer to a cost of the hydrogen charging, and may be determined as a cost for each gram of hydrogen fuel.

The charging standby time item may refer to a standby time for the hydrogen fueled vehicle to start the charging after arriving at the charging station. When pressures of chargers of a current charging station are low, the charging standby time may be long.

The charging taking time item may refer to a time taken in a process of charging the hydrogen fuel of the hydrogen fueled vehicle. The higher the pressure of the charger of the charging station, the shorter the charging taking time may be.

The item of whether the vehicle is able to be fully charged may refer to whether the hydrogen fueled vehicle is able to be fully charged based on the pressure of the fuel tank of the charging station. Among the hydrogen charging stations, there are the charging station at which that the full charging is possible and a charging station at which the full charging is impossible depending on the hydrogen pressure of the fuel tank, so that the item of whether the vehicle is able to be fully charged may be an item which may reflect willingness of the user to fully charge the hydrogen fueled vehicle.

The distance to the charging station item may refer to a travel distance from the vehicle to the charging station, and may be an item which may reflect a tendency of the user to prefer a charging station close to the current location of the vehicle.

The information on the user schedule and the financial status may include information on urgency and expenditure/brand.

As an example, the information on the urgency may be identified through the connected car system and the like.

The information on the urgency may include at least one of information on whether the user is when the user needs to urgently arrive at the destination, which is determined based on the schedule of the user, the travel time to the destination, and the like obtained through the connected car system, and/or information on whether the user is when the user needs to travel the long distance, which is determined based on the distance to the destination obtained through the connected car system.

As an example, the information on the expenditure/brand may be identified through at least one of the connected car system and/or the vehicle payment system.

The information on the expenditure/brand may include at least one of information on a consumption pattern of the user and/or information on the payment scheme and the payment benefit based on the brand of the charging station, which are identified through at least one of the connected car system and/or the vehicle payment system.

FIG. 5 is a diagram showing that a hydrogen charging station guiding device according to various exemplary embodiments of the present invention adjusts a weight based on a charging station selected by a user in the past.

(i) in FIG. 5 is a table showing the default value of the weight for the evaluation item of the hydrogen charging station reflecting the importance obtained from the user.

As an example, when the weight for the evaluation item of the hydrogen charging station reflecting the importance obtained from the user is not input, the hydrogen charging station guiding device 100 may determine a score for each hydrogen charging station based on the default value of the weight, and select the hydrogen charging station which is determined suitable for the hydrogen charging.

As an example, the default values of the weights for the evaluation items of the hydrogen charging station reflecting the importance obtained from the user may be set equally for the items.

When the number of evaluation items of the hydrogen charging station is 5, the default value of the weight for each item may be set to 20%.

(ii) in FIG. 5 is a table showing a situation in which the hydrogen charging station guiding device 100 selects the hydrogen charging station 1 and the hydrogen charging station 2 as the hydrogen charging stations determined to be suitable for the hydrogen charging, and the user selects the hydrogen charging station 2.

When the user selects the hydrogen charging station, the hydrogen charging station guiding device 100 may determine that the user evaluates importance of an item that obtained the highest score of the corresponding charging station high, and select the hydrogen charging station determined to be suitable for the hydrogen charging by increasing a weight of the item that obtained the highest score of the corresponding charging station in next guidance.

The hydrogen charging station 1 may obtain a score of 80 points in the price item because the charging is possible at a price of 1,000 won for each 100 g of the hydrogen fuel, obtain a score of 60 points in the charging standby time item because it takes 40 minutes of standby time to fully charge the charger, obtain a score of 70 points in the charging taking time item because it takes 20 minutes to fully charge the hydrogen fueled vehicle, obtain a score of 50 points because it is possible to fully charge the hydrogen fueled vehicle, and obtain a score of 60 points in the distance to the charging station item because the distance to the charging station is 10 km.

The hydrogen charging station 2 may obtain a score of 50 points in the price item because the charging is possible at a price of 1,200 won for each 100 g of the hydrogen fuel, obtain a score of 70 points in the charging standby time item because it takes 30 minutes of standby time to fully charge the charger, obtain a score of 100 points in the charging taking time item because it takes 0 minutes to fully charge the hydrogen fueled vehicle, obtain a score of 0 points because it is impossible to fully charge the hydrogen fueled vehicle, and obtain a score of 40 points in the distance to the charging station item because the distance to the charging station is 20 km.

When the user selects the hydrogen charging station 2, the hydrogen charging station guiding device 100 may determine that the user evaluates importance of the charging taking time item, which is an item that obtained the highest score of the hydrogen charging station 2, high, and may determine a score by increasing a weight of the charging taking time item in the next guidance.

(iii) in FIG. 5 is a table showing that the weight of the charging taking time item is increased.

When the user selects the hydrogen charging station 2, the hydrogen charging station guiding device 100 may increase the weight of the charging taking time item from 20% to 24%, and accordingly, lower weights of the remaining 4 items equally from 20% to 19%.

Reflecting the information on the hydrogen charging station selected by the user with such scheme is only one example. In fact, the hydrogen charging station guiding device 100 may improve the weight by reflecting the information on the selection of the user with a different scheme, and select the hydrogen charging station determined to be suitable for the hydrogen charging.

FIG. 6 is a view showing that a hydrogen charging station guiding device according to various exemplary embodiments of the present invention adjusts a weight based on feedback of a user.

(i) in FIG. 6 is a table showing weights set before receiving the feedback from the user.

A weight for the price item may be set to 30%, a weight for the charging standby time item may be set to 10%, a weight for the charging taking time item may be set to 40%, a weight for the item of whether the vehicle is able to be fully charged may be set to 10%, and a weight for the distance to the charging station item may be set to 10%.

(ii) in FIG. 6 shows a process in which the hydrogen charging station guiding device 100 guides hydrogen charging station candidates selected as being determined to be suitable for the hydrogen charging in consideration of the existing weights, receives the selection for the hydrogen charging station from the user, and guides the charging station selected by the user.

(iii) in FIG. 6 shows that the hydrogen charging station guiding device 100 has obtained unsatisfactory feedback about the hydrogen charging station selection or guidance from the user.

When obtaining the unsatisfactory feedback about the hydrogen charging station selection or guidance from the user, the hydrogen charging station guiding device 100 may reduce a weight of an item having the highest weight among the evaluation items for the selected hydrogen charging station.

(iv) in FIG. 6 is a table showing that the weight of the item having the highest weight among the evaluation items for the selected hydrogen charging station is reduced.

When obtaining the unsatisfactory feedback about the hydrogen charging station selection or guidance from the user, the hydrogen charging station guiding device 100 may reduce the weight for the charging taking time item having the highest weight among the evaluation items for the selected hydrogen charging station by 4% from 40% to 36%, and accordingly, increase the weights of the remaining items equally by 1%.

Reflecting the feedback from the user with such scheme is only one example. In fact, the hydrogen charging station guiding device 100 may improve the weight by reflecting the feedback from the user with a different scheme, and select the hydrogen charging station determined to be suitable for the hydrogen charging.

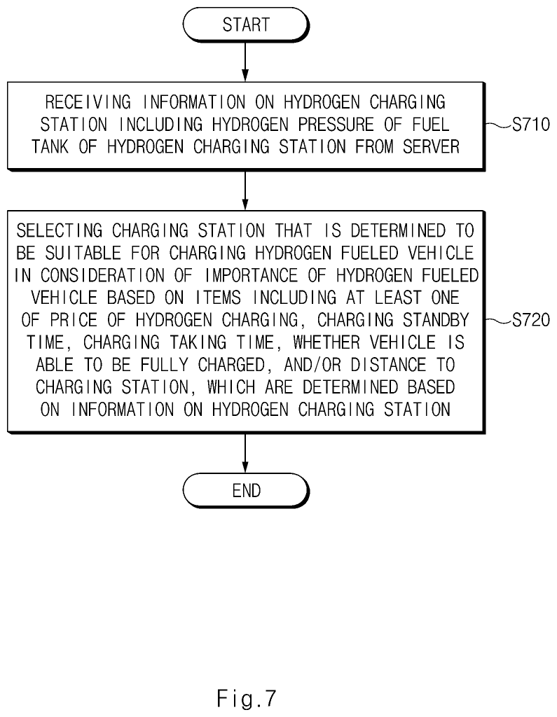

FIG. 7 is a flowchart showing a hydrogen charging station guiding method according to various exemplary embodiments of the present invention.

Referring to FIG. 7, a hydrogen charging station guiding method may include receiving the information on the hydrogen charging station including the hydrogen pressure of the fuel tank of the hydrogen charging station from the server (S710), and selecting the charging station which is determined to be suitable for charging the hydrogen fueled vehicle in consideration of the importance of each item obtained from the user of the hydrogen fueled vehicle based on the items including at least one of the price of hydrogen charging, the charging standby time, the charging taking time, whether the vehicle is able to be fully charged, and/or the distance to the charging station, which are determined based on the information on the hydrogen charging station (S720).

In the hydrogen charging station guiding method, the receiving of the information on the hydrogen charging station including the hydrogen pressure of the fuel tank of the hydrogen charging station from the server (S710) may be performed through the communication devices 110 and 210.

The selecting of the charging station which is determined to be suitable for charging the hydrogen fueled vehicle in consideration of the importance of each item obtained from the user of the hydrogen fueled vehicle based on the items including at least one of the price of hydrogen charging, the charging standby time, the charging taking time, whether the vehicle is able to be fully charged, and/or the distance to the charging station, which are determined based on the information on the hydrogen charging station (S720) may be performed by the controllers 120, 230, and 300.

As an example, the hydrogen charging station guiding method may further include receiving, by the input device 220, the weight based on the importance for the item from the user, and the selecting of the charging station which is determined to be suitable for charging the hydrogen fueled vehicle (S720) may include selecting the charging station which is determined to be suitable for charging the hydrogen fueled vehicle based on the item determined based on the information on the hydrogen charging station in consideration of the input weight.

As an example, the hydrogen charging station guiding method may further include adjusting, by the controllers 120, 230, and 300, the weight based on the importance of the item based on the item determined for the hydrogen charging station selected in the past, and the selecting of the charging station which is determined to be suitable for charging the hydrogen fueled vehicle (S720) may include selecting, by the controllers 120, 230, and 300, the charging station which is determined to be suitable for charging the hydrogen fueled vehicle in consideration of the adjusted weight.

As an example, the hydrogen charging station guiding method may further include adjusting, by the controllers 120, 230, and 300, the weight based on the importance of the item using the feedback of the user on the charging station, which is determined to be suitable for charging the hydrogen fueled vehicle, selected in the past, and the selecting of the charging station which is determined to be suitable for charging the hydrogen fueled vehicle (S720) may include selecting, by the controllers 120, 230, and 300, the charging station which is determined to be suitable for charging the hydrogen fueled vehicle in consideration of the adjusted weight.

As an example, the selecting of the charging station which is determined to be suitable for charging the hydrogen fueled vehicle (S720) may include selecting, by the controllers 120, 230, and 300, the charging station which is determined to be suitable for charging the hydrogen fueled vehicle in consideration of the schedule of the user identified through the hydrogen fueled vehicle.

As an example, the selecting of the charging station which is determined to be suitable for charging the hydrogen fueled vehicle in consideration of the schedule of the user may include selecting, by the controllers 120, 230, and 300, the charging station which is determined to be suitable for charging the hydrogen fueled vehicle based on whether the user is determined through the schedule to be when the user needs to urgently arrive at the destination.

As an example, the selecting of the charging station which is determined to be suitable for charging the hydrogen fueled vehicle in consideration of the schedule of the user may include selecting, by the controllers 120, 230, and 300, the charging station which is determined to be suitable for charging the hydrogen fueled vehicle based on whether the user is determined through the schedule to be when the user needs to travel the long distance.

As an example, the selecting of the charging station which is determined to be suitable for charging the hydrogen fueled vehicle (S720) may include selecting, by the controllers 120, 230, and 300, the charging station which is determined to be suitable for charging the hydrogen fueled vehicle in consideration of the financial status of the user identified through the hydrogen fueled vehicle.

As an example, the selecting of the charging station which is determined to be suitable for charging the hydrogen fueled vehicle (S720) may include selecting, by the controllers 120, 230, and 300, the charging station which is determined to be suitable for charging the hydrogen fueled vehicle in consideration of the payment method of the user identified through the hydrogen fueled vehicle and the benefit based on the hydrogen charging station.

The operations of the method or the algorithm described in connection with the exemplary embodiments disclosed herein may be embodied directly in hardware or a software module executed by the processor, or in a combination thereof. The software module may reside on a storage medium (that is, the memory and/or the storage) such as a RAM, a flash memory, a ROM, an EPROM, an EEPROM, a register, a hard disk, a removable disk, and a CD-ROM.

The exemplary storage medium is coupled to the processor, which may read information from, and write information to, the storage medium. In another method, the storage medium may be integral with the processor. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present invention, and various modifications and changes may include those skilled in the art without departing from the essential characteristics of the present invention.

Therefore, the exemplary embodiments disclosed in various exemplary embodiments of the present invention are not intended to limit the technical idea of the present invention but to illustrate the present invention, and the scope of the technical idea of the present invention is not limited by the embodiments. The scope of the present invention should be construed as being covered by the scope of the appended claims, and all technical ideas falling within the scope of the claims should be construed as being included in the scope of the present invention.

Effects of the device and the method for guiding the hydrogen charging station according to various exemplary embodiments of the present invention are as follows.

According to at least one of the exemplary embodiments of the present invention, the device and the method for guiding the hydrogen charging station based on the hydrogen pressure in the fuel tank of the hydrogen charging station may be provided.

Furthermore, according to at least one of the exemplary embodiments of the present invention, the device and the method for guiding the hydrogen charging station which may save the time for the user of the hydrogen fueled vehicle by recommending the charging station suitable for charging the hydrogen fueled vehicle.

Furthermore, according to at least one of the exemplary embodiments of the present invention, the device and the method for guiding the hydrogen charging station which may provide the highest economic satisfaction to the user by guiding the charging station in consideration of the price, the balance, the economic benefit, and the like may be provided.

Furthermore, according to at least one of the exemplary embodiments of the present invention, the device and the method for guiding the hydrogen charging station which may give the user the great satisfaction by guiding the charging station with the high satisfaction in consideration of the personal taste of the user by reflecting the preference of the user may be provided.

Furthermore, according to at least one of the exemplary embodiments of the present invention, the device and the method for guiding the hydrogen charging station which may guide the more improved hydrogen charging station in the next round by reflecting the hydrogen charging station selected by the user or the feedback of the user may be provided.

Furthermore, various effects that are directly or indirectly identified through the present specification may be provided.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A device for guiding a hydrogen fueled vehicle, the device comprising:
a communication device configured for receiving information on a hydrogen charging station including a hydrogen pressure of a fuel tank of the hydrogen charging station, from a server; and
a controller configured to select a charging station determined to be suitable for charging the hydrogen fueled vehicle in consideration of an importance of each item obtained from a user of the hydrogen fueled vehicle based on items including at least one of a price of hydrogen charging, a charging standby time, a charging taking time, whether the hydrogen fueled vehicle is able to be fully charged, and a distance to the hydrogen charging station determined based on the information on the hydrogen charging station.

2. The device of claim 1, further including:
an input device configured for receiving a weight based on the importance of each item from the user,
wherein the controller is configured to select the hydrogen charging station determined to be suitable for charging the hydrogen fueled vehicle based on the items determined based on the information on the hydrogen charging station in consideration of the received weight.

3. The device of claim 1, wherein the controller is configured to select the hydrogen charging station determined to be suitable for charging the hydrogen fueled vehicle in consideration of the importance of the items based on the user determined based on information on a hydrogen charging station selected by the user in the past.

4. The device of claim 1, wherein the controller is configured to:
adjust a weight based on the importance of the items based on an item determined for a hydrogen charging station selected in the past; and
select the hydrogen charging station determined to be suitable for charging the hydrogen fueled vehicle in consideration of the adjusted weight.

5. The device of claim 1, wherein the controller is configured to select the hydrogen charging station determined to be suitable for charging the hydrogen fueled vehicle in consideration of feedback of the user on a charging station determined to be suitable for charging the hydrogen fueled vehicle selected in the past.

6. The device of claim 5, wherein the controller is configured to:
adjust a weight based on the importance of the items using the feedback of the user; and
select the hydrogen charging station determined to be suitable for charging the hydrogen fueled vehicle in consideration of the adjusted weight.

7. The device of claim 1, wherein the controller is configured to select the hydrogen charging station determined to be suitable for charging the hydrogen fueled vehicle in consideration of a schedule of the user identified through the hydrogen fueled vehicle.

8. The device of claim 7, wherein the controller is configured to select the hydrogen charging station determined to be suitable for charging the hydrogen fueled vehicle based on whether it is determined through the schedule that the user needs to urgently arrive at a destination.

9. The device of claim 7, wherein the controller is configured to select the hydrogen charging station determined to be suitable for charging the hydrogen fueled vehicle based on whether it is determined through the schedule that the user needs to travel a distance longer than a predetermined distance.

10. The device of claim 1, wherein the controller is configured to select the hydrogen charging station determined to be suitable for charging the hydrogen fueled vehicle in consideration of a financial status of the user identified through the hydrogen fueled vehicle.

11. The device of claim 1, wherein the controller is configured to select the hydrogen charging station determined to be suitable for charging the hydrogen fueled vehicle in consideration of a payment method of the user identified through the hydrogen fueled vehicle and a benefit based on the hydrogen charging station.

12. A method for guiding a hydrogen fueled vehicle, the method comprising:
receiving, by a communication device, information on a hydrogen charging station including a hydrogen pressure of a fuel tank of the hydrogen charging station from a server; and
selecting, by a controller, a charging station determined to be suitable for charging the hydrogen fueled vehicle in consideration of an importance of each item obtained from a user of the hydrogen fueled vehicle based on items including at least one of a price of hydrogen charging, a charging standby time, a charging taking time, whether the hydrogen fueled vehicle is able to be fully charged, and a distance to the hydrogen charging station determined based on the information on the hydrogen charging station.

13. The method of claim 12, further including:
receiving, by an input device, a weight based on the importance of each item from the user,
wherein the selecting, by the controller, of the hydrogen charging station determined to be suitable for charging the hydrogen fueled vehicle includes:
selecting, by the controller, the hydrogen charging station determined to be suitable for charging the hydrogen fueled vehicle based on the items determined based on the information on the hydrogen charging station in consideration of the received weight.

14. The method of claim 12, further including:
adjusting, by the controller, a weight based on the importance of the items based on an item determined for a hydrogen charging station selected in the past,
wherein the selecting, by the controller, of the hydrogen charging station determined to be suitable for charging the hydrogen fueled vehicle includes:
selecting, by the controller, the hydrogen charging station determined to be suitable for charging the hydrogen fueled vehicle in consideration of the adjusted weight.

15. The method of claim 12, further including:
adjusting, by the controller, a weight based on the importance of the items based on feedback of the user on a charging station determined to be suitable for charging the hydrogen fueled vehicle selected in the past,
wherein the selecting, by the controller, of the hydrogen charging station determined to be suitable for charging the hydrogen fueled vehicle includes:
selecting, by the controller, the hydrogen charging station determined to be suitable for charging the hydrogen fueled vehicle in consideration of the adjusted weight.

16. The method of claim 12, wherein the selecting, by the controller, of the hydrogen charging station determined to be suitable for charging the hydrogen fueled vehicle includes:
selecting, by the controller, the hydrogen charging station determined to be suitable for charging the hydrogen fueled vehicle in consideration of a schedule of the user identified through the hydrogen fueled vehicle.

17. The method of claim 16, wherein the selecting, by the controller, of the hydrogen charging station determined to be suitable for charging the hydrogen fueled vehicle in consideration of the schedule of the user includes:
selecting, by the controller, the hydrogen charging station determined to be suitable for charging the hydrogen fueled vehicle based on whether it is determined through the schedule that the user needs to urgently arrive at a destination.

18. The method of claim 16, wherein the selecting, by the controller, of the hydrogen charging station determined to be suitable for charging the hydrogen fueled vehicle in consideration of the schedule of the user includes:
selecting, by the controller, the hydrogen charging station determined to be suitable for charging the hydrogen fueled vehicle based on whether it is determined through the schedule that the user needs to travel a distance longer than a predetermined distance.

19. The method of claim 12, wherein the selecting, by the controller, of the hydrogen charging station determined to be suitable for charging the hydrogen fueled vehicle includes:
selecting, by the controller, the hydrogen charging station determined to be suitable for charging the hydrogen fueled vehicle in consideration of a financial status of the user identified through the hydrogen fueled vehicle.

20. The method of claim 12, wherein the selecting, by the controller, of the hydrogen charging station determined to be suitable for charging the hydrogen fueled vehicle includes:
selecting, by the controller, the hydrogen charging station determined to be suitable for charging the hydrogen fueled vehicle in consideration of a payment method of the user identified through the hydrogen fueled vehicle and a benefit based on the hydrogen charging station.
